(19) United States
(12) Patent Application Publication
(10) Pub. No.: US 2008/0262258 A1
(43) Pub. Date: Oct. 23, 2008

(54) Container For Forming Self-Baking Electrodes

(75) Inventor: Atila Benito Pimenta Rodrigues, Minas Gerais (BR)

Correspondence Address: DOW CORNING CORPORATION CO1232, 2200 W. SALZBURG ROAD, P.O. BOX 994, MIDLAND, MI, 48686-0994, US

(73) Assignee: DOW CORNING CORPORATION, Midland, MI (US)

(21) Appl. No.: 10/594,352

(22) PCT Filed: Apr. 4, 2005
(86) PCT No.: PCT/US2005/011409

§ 371 Date: Jun. 15, 2008

Related U.S. Application Data
(60) Provisional application No. 60/567,976, filed on May 4, 2004.

(51) Int. Cl. C07F 7/00; C01B 33/023; H05F 3/00; H05B 7/09; H01R 43/00

(52) U.S. Cl. 556/472; 423/350; 204/164; 373/89; 29/746

(57) ABSTRACT

A container for forming an electrode that can be used in electric reduction furnaces. The container comprises a cylindrical casing. Within the cylindrical casing is a plurality of ribs attached along the inner surface of the casing lengthwise of the cylindrical casing. At least one of the ribs in the container is made of a material comprising copper.

The present invention relates to self-baking electrodes for use in electric reduction furnaces, and in particular it relates to a container for forming self-baking electrodes to be used in electric reduction furnaces. The invention also relates to a method of forming a self-baking electrode using this container as well as the electrode formed thereby. Finally, the invention relates to the use of a self-baking electrode formed in this container for manufacturing silicon and silicon alloys.

Conventional self-baking electrodes are formed in segmented cylindrical containers, typically comprising sections of casings that are stacked on top of each other vertically. Typically, these stacks of casing extend from inside the electric reduction furnace at least to a height above the furnace, and they often extend far higher as necessary for the operation. The upper end of the cylindrical container is open in order to allow the addition of unbaked electrode paste. During operation, electrode paste is poured into the open end of the container and it travels down through the sections of casing until it is subjected to the heat generated by the electric current flowing through the electrode during the electric reduction furnace operation. At the point of heating, the paste softens, melts, discharges volatile products, and is baked into a solid carbon electrode within the container. As the electrode is consumed in the furnace, the container containing the electrode is lowered and new sections of casing are installed at the top of the column, where additional unbaked electrode paste is usually added.

Conventional casings of the type used to form such electrodes are equipped with metallic ribs affixed to the inner surface of the vertical casing, the ribs extending radially relative to the axis of the electrode. When a new section of casing is installed at the top of the electrode column, its casing and its ribs are welded to the casing and ribs of the already installed segment in order to obtain continuity of the ribs in the vertical direction. The ribs serve to support the formed electrode and conduct electric current and heat into the electrode during the baking process. The casing sections are lowered into the furnace by means of the sliding mechanism as the electrode is consumed.

When conventional electrodes of this type are used, the electrode, its container and the inner ribs are consumed in the furnace. As such, the metal content of the container and the ribs is transferred to the product in the furnace. Since the container and the inner ribs are often made from carbon steel, such self-baking electrodes cannot be used in electric reduction furnaces for the production of high-grade (high purity) silicon or silicon alloys, as the iron content in the material produced will become unacceptable.

When the silicon metal produced in an electric reduction furnaces is to be used in the manufacture of silanes and silicones (e.g., via the direct process), it needs to have very low levels of impurities. Moreover, processes for the manufacture of silanes and silicones by methods such as the direct process often require the presence of catalysts such as copper.

The present invention relates to a container for forming an electrode which can be used in an electric reduction furnaces. The container comprises a cylindrical casing. Within the cylindrical casing are a plurality of ribs attached along the inner surface of the casing lengthwise of the cylindrical casing. At least one of the ribs in the container is made of a copper alloy.

The present invention also relates to a method of forming an electrode comprising adding unbaked electrode paste into an electrode container comprising a cylindrical casing containing therein a plurality of ribs attached along the inner surface of the casing lengthwise of the cylindrical casing, wherein at least one of the ribs is made of a copper alloy. The paste is then heated to form the electrode.

The present invention also relates to a method for manufacturing silicon and silicon alloys with low contaminant content using a self baking electrode. The method comprises forming an electrode in an electrode container comprising a cylindrical casing containing therein a plurality of ribs attached along the inner surface of the casing lengthwise of the cylindrical casing, wherein at least one of the ribs is made of a copper alloy. The electrode is used in a low electric reduction furnace having silicon metal present until the desired silicon or silicon alloy is produced.

### DESCRIPTION OF THE DRAWINGS

The following drawings and descriptions provide representative embodiments of the invention, but the limitations included therein are not meant to limit the invention or narrow the scope of the claims.

FIG. 1 is a cross-sectional view through a container for the formation of self-baking electrodes to be used in an electric reduction furnace in accordance with the present invention.

FIG. 2 is a horizontal view taken along plane I-I of the container depicted in FIG. 1.

FIG. 3 shows the attachment of one rib in the casing and the alternating and offset holes provided in the rib.

FIG. 4 is a frontal view of one complete section of the casing and showing the ribs extending beyond the container section.

### DESCRIPTION

The present invention relates to a container used in the formation of a self-baking electrode. The container comprises a cylindrical casing. Within the cylindrical casing is a plurality of ribs attached along the inner surface of the casing lengthwise of the cylindrical casing. At least one of the ribs in the container comprises copper, e.g., copper or a copper alloy. Electrode paste is initially added to the container in raw unbaked form. With the passage of the electric current through the container and ribs, it is baked and forms a solid electrode, typically comprising carbon. When such an electrode is used in an electric reduction furnace to make silicon, the electrode and the container are consumed and incorporated in the content of the silicon. The process of the present invention allows for the production of silicon and silicon alloys that can be low in contamination and that also contain copper that can be beneficial in the subsequent process of converting silicon metal into silanes and silicones.

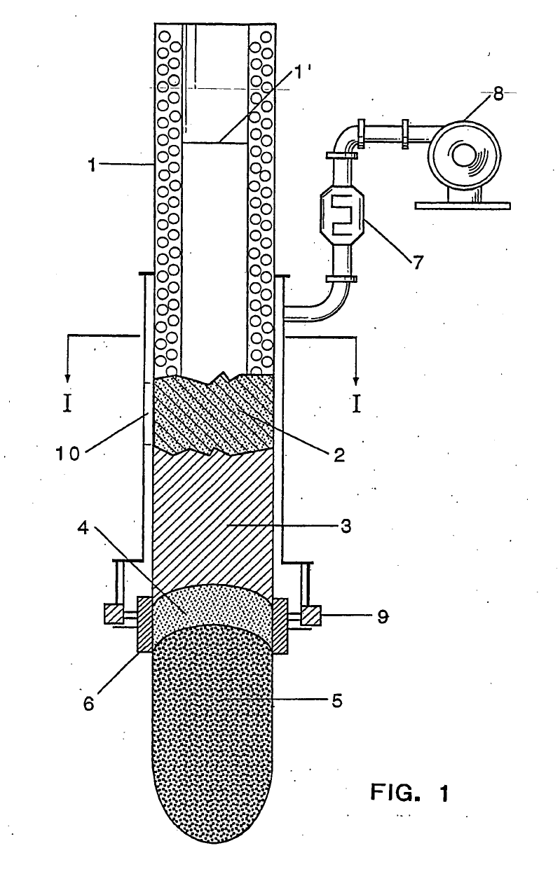

FIG. 1 is a drawing of a representative container for producing self-baking electrodes. The container (1) is typically cylindrical and can be segmented into casing sections (1′) of a length desirable for the furnace configuration. Likewise, the container can be split into multiple parts along, for example, the plane I-I. As an example, the container can be split into halves along the plane I-I for production and then assembled together by, for example, welding prior to use. Since the container is typically formed of multiple casing sections, it can extend from the inside of the furnace stack until the height desired, such as from just above the furnace up to the uppermost height of the building housing the same.

The casing of the container (1) is typically made of a material comprising aluminum. In one embodiment, the container is entirely aluminum. In other embodiments, the container is made of an aluminum alloy. The alloy could include, for example, silicon, stainless steel, carbon steel, iron or other metals that may be useful for container properties (e.g., hardness, strength, heat resistance, impurities and the like) or it may include materials that may be useful in further processing of the silicon or silicon alloy that results from the furnace (e.g., copper or other catalysts useful in the production of silanes or silicones). In yet another embodiment, the casing can be made of conventional materials such as carbon steel or stainless steel, but in such an embodiment the silicon or silicon alloy produced in the reduction furnace may contain contaminants from said material. The casing is typically about 2.5 to 3.0 mm thick, although thinner or thicker specifications will also work. The casing sections are typically 0.5 to 3 m in diameter and 0.5 to 10 m in length depending on furnace design.

The upper end of the cylindrical container (1) is open to allow the addition of unbaked electrode paste (2). The electrode paste used in this process is well know in the art and can be purchased commercially from any Soderberg paste producer. Typically, the electrodes formed by this process comprise carbon.

The raw unbaked electrode paste (2) is converted into a calcined electrode (5) by the addition of heat. As the paste is heated, however, it is first converted into a fluid paste (3), a partially calcined electrode (4) and then the final calcined electrode (5). The heat for this calcination can be supplied from any desirable source. For example, it can be any of the known conventional heaters or it can be by heat supplied by the induction in the furnace. In the embodiment depicted in FIG. 1, the heat is supplied by the hot air blown-in (originating from fan (8) and from heater (7)), as well as by the heat generated by the introduction of electric energy through the contact plates (6), which are pressed against the electrode by pressure ring (9). The electrical energy is transferred to the electrode through the contact plates and these pressure rings insure contact between the contact plates and the casing. The pressure rings (9) can be made of any desirable material such as iron, stainless steel, aluminum, or other materials used in the casing as described above. If desired and as shown in the embodiment of FIG. 1, the casing segments above the contact plates can be enclosed by a protective shield (10) to sustain the system formed by the pressure ring and the contact plates. The protective shield, too, can be made of any desirable material such as iron, stainless steel, aluminum, or other materials used in the casing as described above.

The contact plates (6) are the points where the electric energy is transferred to the casing and, thus, the electrode. The contacts are of a size necessary to transmit the necessary electrical energy and they can be made of any electrically conductive material such as copper or steel.

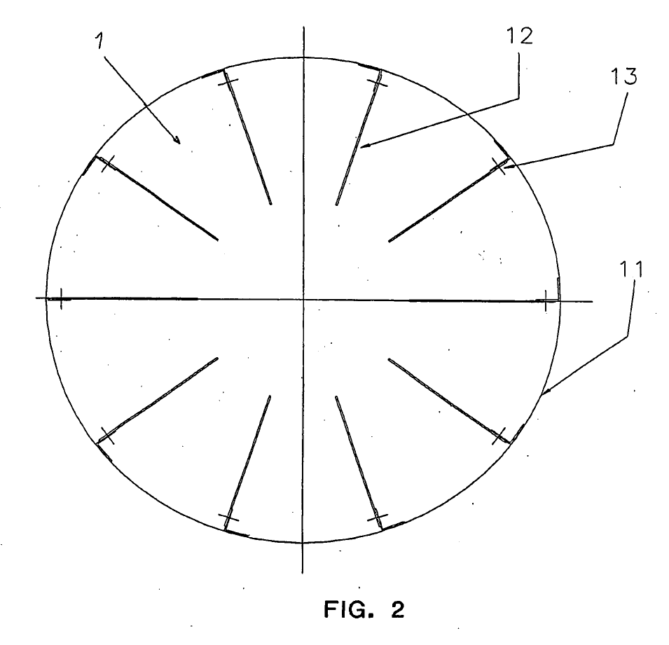

In FIG. 2 there is depicted the casing (1), seen in cross section along the plane I-I of FIG. 1. As will be noted, the container (1) is comprised of a cylindrical casing (11). On the inside of the casing there are a plurality of ribs (12) attached to the inner wall of the casing (11). Preferably, the ribs are attached approximately perpendicular to the inner wall of the casing (11). In the embodiment shown in FIG. 2, they are arranged axially. In one embodiment of the invention, the ribs (12) are attached on the inner wall of the casing (11) at uniform intervals—i.e., the distance between the ribs on the inner wall of the casing is uniform.

The number of ribs used, the length they extend from the inner wall of the casing and their thickness are all selected based on the specific requirements of the electrode to be formed. For example, a heavier electrode may require either more ribs or thicker ribs depending on the design. Typically, however, there will be 2-12 ribs. They typically extend from 5 to 50% of the radial distance across the casing. They are typically 2 to 4 (e.g., 3.2) mm thick, although thinner or thicker specifications will also work.

At least one of the ribs (12) of the present invention comprise copper. For example, the rib can be copper, a copper alloy or it can be copper containing other materials that may be useful in further processing of the silicon or silicon alloy that results from the furnace. Examples of copper alloys include brass or CuCr. If desired, some of the ribs may be made of other materials such as stainless steel or aluminum.

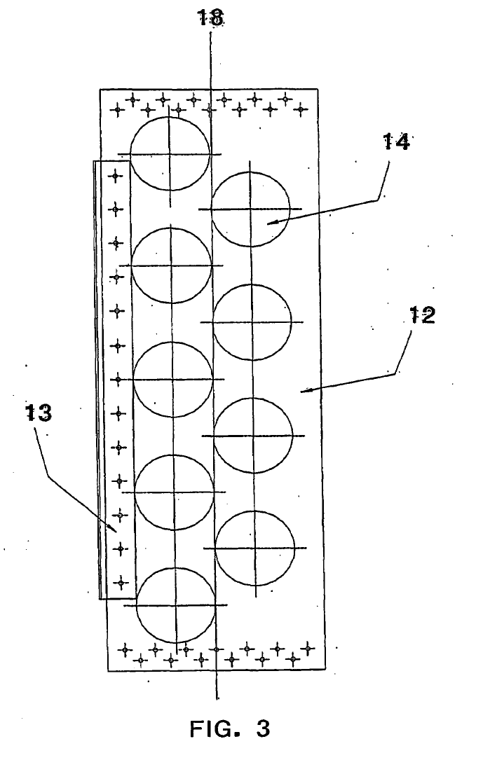

FIG. 2 also shows the attachment of rib (12) to the casing (11). This attachment can be made by known techniques. As shown in the embodiments of FIGS. 2 and 3, an aluminum angle bar (13) is welded to the inner wall of the casing (11) and then the rib (12) is fastened to the aluminum angle bar (13) by means of a screw. This approach may be desirable when the metals of the rib and the casing are different. Obviously, the angle bar in this embodiment can be made of other suitable materials. In other embodiments, however, the ribs can be attached by other means.

FIG. 3 depicts the construction of the rib (12) in front view. In this embodiment, the rib (12) has holes (14) in it. If desired, the ribs can be enhanced in strength or reduced in weight. For example, the ribs could contain holes drilled therein with, for example, flanges protruding from around the holes. Similarly, the ribs can be bent at various locations (e.g., the ends) to increase their strength. While the holes (14) can be of nearly any size (e.g., 1 mm to 100 cm) and in any configuration desired, this embodiment shows the holes as offset from an axis (18) drawn down the rib and the holes (14) are alternating on either side of this axis. This arrangement is also thought to increase the strength of the rib.

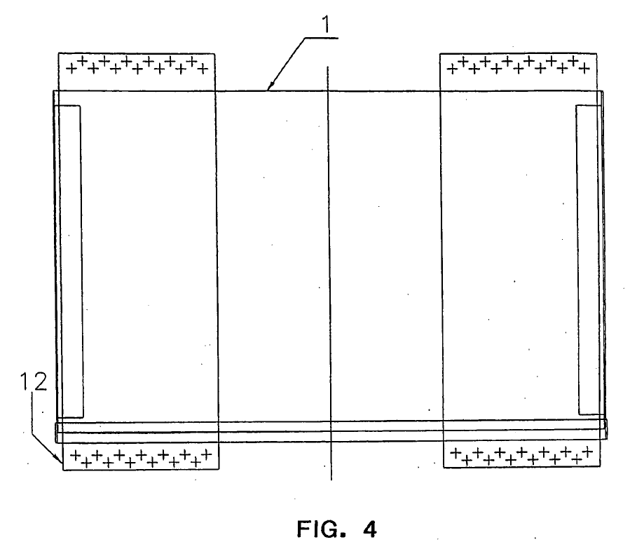

FIG. 4 shows one embodiment of a frontal view of a section of casing according to the invention. In this embodiment, the ribs (12) extend beyond both ends of the length of the casing (1). This facilitates the connection of ribs from one casing section to another to support the weight of the electrode. This connection can be made by any conventional technique such as screwing, welding, rivets and the like. In one embodiment, for example, the ribs extend on the order of 5 min to 15 cm beyond the ends of the casing.

When stacked on top of each other, the casing sections (1) also need to be connected. Again, this can be by conventional techniques for bonding the casing materials such as welding.

The present invention allows for a decrease in the contribution of contaminants such as “Iron” to the product produced in the electric reduction furnace in which the electrode is used. Moreover, the present invention allows for the introduction of copper and other metals that may be useful in the further processing of the silicon or silicon alloy produced in the electric reduction furnace.

The electrodes formed in the containers of this invention can be used in the manufacture of silicon containing materials such as silicon and ferrosilicon. Typically, such a process comprises feeding silicon dioxide (quartz) and carbonaceous reducing agents such as a coal, coke, woodchips, charcoal, or a mixture thereof into an electric reduction furnace. For alloy production, the feed also includes an alloying metal such as iron. During the furnace operation, intensely hot plasma is typically established beneath the furnace burden, i.e., the permeable mass of charge materials in the furnace body in various stages of physical and chemical modification resulting from the heat and ensuing reactions. Liquid metal product collects in the furnace, and it is tapped off periodically or continually. Gases, including carbon monoxide and gaseous silicon oxide, are formed and given off. Reducing conditions for converting the mixture of carbonaceous reducing agent and silicon dioxide into liquid phase elemental silicon in a smelting operation include a temperature high enough to liberate the metal and fuse it, typical of an arc furnace, and an excess of carbonaceous reductant for the reduction of the silica. This process is known in the art and is described, for example, in U.S. Pat. Nos. 875,672, 3,887,359, 4,269,620, 4,366,137, 4,450,003, 4,865,643 and 4,997,474, all of which are incorporated by reference herein.

The silicon produced in the process contains the copper introduced via the rib(s). As noted above, this copper can be beneficial in the production of silanes via the Direct Process reaction in which an alkylhalide (e.g., methylchloride) is reacted with silicon metal at elevated temperatures (e.g., 250-350 C) in the presence of catalysts such as copper to produce a mixture of silanes including trimethylchlorosilane, dimethyldichlorosilane, methyltrichlorosilane tetramethylsilane, silicon tetrachloride, trichlorosilane, methyldichlorosilane and dimethylchlorosilane. This is taught, for example, in U.S. Pat. Nos. 2,380,995, 2,383,818, 2,443,902, 2,464,033, 2,666,775, 2,666,776, 3,446,829, 4,218,387, 4,487,950, 4,500,724, 4,503,165, and 4,504,596, all of which are incorporated by reference herein. The resultant silanes, in turn, are hydrolyzed and condensed to form polysiloxanes.

1. A container for the formation of self-baking electrodes for use in electric reduction furnaces comprising:
a cylindrical casing;
within the cylindrical casing are a plurality of ribs attached along the inner surface of the casing lengthwise of the cylindrical casing, wherein at least one of the ribs is made of a material comprising copper.

2. The container according to claim 1 wherein the cylindrical casing is made of a material comprising aluminum.

3. The container according to claim 1 wherein each of the ribs have circular holes arranged alternately and offset from an axis that runs down the rib parallel to the inner surface of the cylindrical casing.

4. The container according to claim 1 wherein each of the ribs is attached to the casing by means of screws.

5. The container according to claim 1 wherein each of the ribs are attached approximately perpendicularly to the inner surface of the casing.

6. The container according to claim 5, wherein each of the ribs has circular holes arranged alternately and offset from an axis that runs down the rib parallel to the inner surface of the cylindrical casing.

7. The container according to claim 1, wherein the container further comprises electrode paste.

8. A container according to claim 1, wherein the casing is split lengthwise into 2 halves.

9. A container according to claim 1 wherein all of the ribs are made of a copper alloy.

10. A method of forming an electrode comprising:—
adding unbaked electrode paste to an electrode container comprising a cylindrical casing containing therein a plurality of ribs attached along the inner surface of the casing lengthwise of the cylindrical casing, wherein at least one of the ribs is made of a material comprising copper; and
heating the paste to form the electrode.

11. An electrode produced in accordance with the method of claim 10.

12. A method for manufacturing silicon using a self baking electrode comprising:
forming an electrode in an electrode container comprising a cylindrical casing containing therein a plurality of ribs attached along the inner surface of the casing lengthwise of the cylindrical casing, wherein at least one of the ribs is made of a material comprising copper;
introducing the electrode into an electric reduction furnace containing silicon dioxide and a carbonaceous reducing agent; and
running electrical energy through the electrode until the desired silicon is produced.

13. The silicon produced by the method of claim 12.

14. A method of producing silanes comprising reacting an alkylhalide with the silicon metal of claim 13 at an elevated temperature.
